(19) United States
(12) Patent Application Publication
(10) Pub. No.: US 2005/0048182 A1
(43) Pub. Date: Mar. 3, 2005

(54) Composite food product

(76) Inventors: Mark King, Battle Creek, MI (US); Charles Gambino, Kalamazoo, MI (US); Diana Lynne Busse Seevers, Kalamazoo, MI (US); Michael N. Bauman, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/927,598

(22) Filed: Aug. 26, 2004

Related U.S. Application Data
(60) Provisional application No. 60/499,114, filed on Aug. 29, 2003.

(51) Int. Cl. A23B 4/00

(52) U.S. Cl. 426/549

(57) ABSTRACT

The present invention provides a method including the step of depositing a quantity of a first batter on a baking surface. The first batter is cooked on the baking surface for a first period of time. The method also includes the step of placing a base food product over the first batter on the baking surface. The base food product and the first quantity of batter are cooked together for a second period of time. The base food product and the first quantity of batter are bonded together during the second cooking step. The first batter forms a decorative or aesthetic food product and is combined with the base food product to form a composite food product.

### CROSS-REFERENCE TO RELATED APPLICATIONS

This application claims the benefit of U.S. provisional patent application Ser. No. 60/499,114 for an APPLICATION OF 3D SHAPES TO FOOD PRODUCTS, filed on Aug. 29, 2003, which is hereby incorporated by reference in its entirety. This claim is made under 35 U.S.C. § 119(e); 37 C.F.R. § 1.78; and 65 Fed. Reg. 50093.

### BACKGROUND OF THE INVENTION

1. Field of the Invention

The invention relates to a food product and more particularly to a food product having a decorative or aesthetic portion.

2. Description of Related Art

Food products can be formed with decorative portions, such as ornamental structures and surface indicia. It can be desirable to manufacture a food product with ornamental structures and surface indicia to enhance the visual appeal of the food product. For example, manufactured food products can be shaped to correspond to the shape of naturally grown or cultivated foods, raising the inference that the manufactured product and the natural product have a similar taste. In addition, it can be desirable to manufacture a food product with ornamental structures and surface indicia to distinguish one brand of food product from another brand of food product. A producer can gain a marketable advantage over the competition by producing a product that is readily distinguished from the rest of the products being marketed. For example, candy bars and cookies are manufactured with the brand name of the product on the surface of the product. Also, the enjoyment of consuming a food product can be enhanced by forming festive or decorative shapes on the product. Therefore, it would be desirable to enhance food products by providing an ornamental structure that is decorative and distinctive.

### SUMMARY OF THE INVENTION AND ADVANTAGES

The present invention provides a method including the step of depositing a quantity of a first batter on a baking surface. The first batter is cooked on the baking surface for a first period of time. The method also includes the step of placing a base food product over the first batter on the baking surface. The base food product and the first quantity of batter are cooked together for a second period of time. The base food product and the first quantity of batter are bonded together during the second cooking step. The first batter is a decorative or aesthetic food product and is combined with the base food product to form a composite food product.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a simplified flow diagram illustrating the steps for preparing a food product according to an exemplary embodiment of the present invention;

FIG. 2 is a schematic cross-sectional view of a composite food product being formed in a mold with a decorative food product and a pre-prepared base food product;

FIG. 3 is a schematic cross-sectional view of a composite food product being formed in a mold with a decorative food product and a base food product in batter form;

FIG. 4 is a perspective view of a mold assembly used to produce the food product shown in FIGS. 5-7;

FIG. 5 is a perspective view of a composite food product prepared in accordance with one embodiment of the present invention;

FIG. 6 is top view of the food product shown in FIG. 5;

FIG. 7 is a cross-sectional view of the food product shown in FIG. 6, taken through line 7-7;

FIG. 8 is a perspective view of a portion of an assembly line for manufacturing a food product according to an embodiment of the present invention;

FIG. 9 is a simplified flow diagram illustrating the steps for preparing a food product according to another exemplary embodiment of the present invention;

FIG. 10 is a perspective view of a portion of an assembly line for manufacturing a food product according to the second embodiment of the present invention; and

FIG. 11 is a perspective view of a composite food product according to another embodiment of the invention.

### DETAILED DESCRIPTION OF THE PREFERRED EMBODIMENT

A plurality of different embodiments of the invention are shown in the figures of the application. Similar features are shown in the various, different embodiments of the invention. Similar features have been numbered with a common reference numeral and have been differentiated by an alphabetic designation after the common reference numeral or by a third digit placed before two common digits. Similar features are structured similarly, operate similarly, and/or have the same function unless otherwise indicated by the drawings or this specification. Furthermore, particular features of one embodiment can be exchanged with corresponding features in another embodiment unless otherwise indicated by the drawings or this specification.

The present invention provides a method that can be applied to form a composite food product; the composite food product comprising a decorative food product and a base food product. The method includes the step of depositing a quantity of a first batter on a baking surface. The first batter is cooked on the baking surface for a first period of time and forms the decorative food product. The method also includes the step of placing a base food product over the first batter on the baking surface after the first period of time. The base food product and the first quantity of batter are cooked together for a second period of time. The base food product and the first quantity of batter are bonded together during the second cooking step. Several embodiments of the invention are set forth below, including one exemplary embodiment of the method in which a mold encloses the first batter and the base food product. In alternative embodiments, both the first batter and the base food product are cooked on a substantially flat baking surface. As used herein, a baking surface is a heat conducting surface. The baking surface can be defined by a waffle iron, a baking pan, a griddle, a mold, or any other baking/cooking surface known in the art.

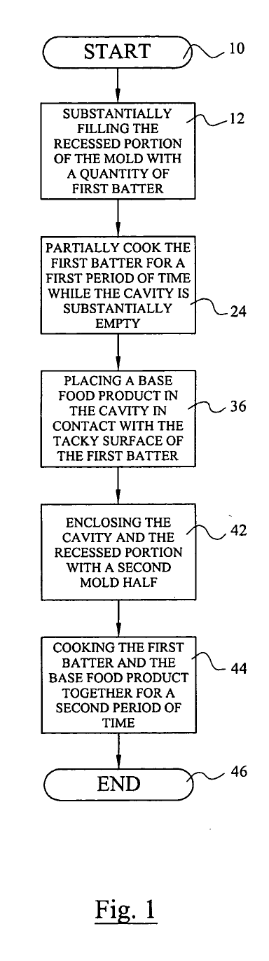

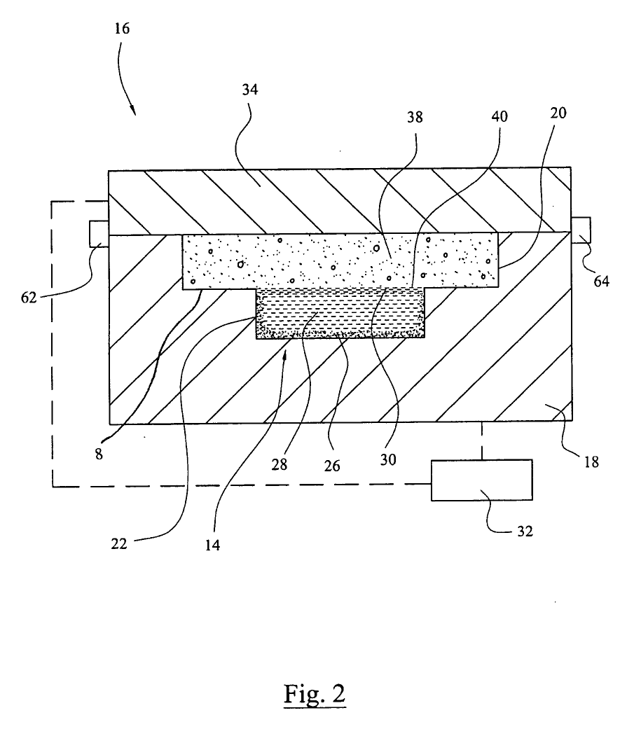

One embodiment of the method disclosed by the present invention is shown in the simplified flow diagram of FIG. 1. The process starts at step 10. Referring now to FIGS. 1 and 2, the process continues to step 12 wherein a recessed portion 22 of a mold 16 is substantially filled with a quantity of a first batter for forming a decorative food product 14. The recessed portion 22 of the mold 16 can be recessed between one-eighth (⅛) inch to one-quarter (¼) inch relative to a cavity 20 of the mold 16. The mold 16 includes a first mold half 18 which defines the cavity 20 and the recessed portion 22, which is recessed from the cavity 20. The cavity 20 defines a baking surface 8. The recessed portion 22 can be shaped to correspond to a graphical image, such as the shape of an animal, an object, a symbol, or a logo. In addition or alternatively, the recessed portion 22 can be shaped to correspond to textual, three-dimensional indicia, such as a word, a phrase, a number, or a letter.

The first batter for forming the decorative food product 14 is dispensed into the portion 22 to substantially fill the recessed portion 22. The recessed portion 22 is filled in response to the cooking properties of the first batter. For example, the recessed portion 22 may be half-filled with batter if the batter expands relatively greatly during cooking to fill the recessed portion 22. Alternatively, the recessed portion 22 may be almost completely filled with batter if the batter expands relatively slightly during cooking to fill the recessed portion 22.

The first batter for forming the decorative food product 14 can be any type of batter used for forming an edible food product. For example, the decorative food product 14 can be made from batter for making cakes, pancakes, waffles, or biscuits. The first batter can be aerated or non-aerated. Food coloring can be added to the first batter. The food coloring can be encapsulated in a temperature sensitive medium that releases the food coloring when the decorative food product 14 is being heated, such as in a toaster. Aroma-emitting means can also be incorporated into the first batter. The first batter 14 can include more than one different batters. For example, a clown's face can be formed with a first batter of white for the eyes and red for the nose and blue for the mouth. The white, red and blue batters can be dispensed substantially concurrently and constitute the first batter 14. The plurality of batters used for the first batter can be different in terms of taste, color, or texture, or any combination of taste, color, and texture.

The first batter can be formed from a plurality of ingredients. The batter can include water, flour, oil, eggs, salt, flavorings and colorings. The batter can also include ingredients that enhance shelf-life and manufacturability, as well as fortificants. The batter can include sweeteners such as granulated sugar or corn syrup.

In a more preferred embodiment, the first batter can be 30-65% water by weight, 25-70% flour by weight, 0-10% shortening by weight, 0-10% liquid eggs by weight, 0-4% sweet whey powder by weight, 0-8% granulated sugar by weight, 0-1.5% salt by weight, 0.05-2.5% sodium bicarbonate by weight, 0.04-2% sodium aluminum phosphate by weight, 0-0.3% monocalcium phosphate by weight, calcium carbonate by weight 0 to 1.5%, and 0-0.1% vitamin/mineral/color premix by weight. All weights based on the total weight of the batter.

In general, batter is a homogeneous mixture of the following: water between 30 to 65%; flour 25 to 70%; shortening 2-15%; eggs, fresh, liquid 0 to 10%; sugar, granulated 0 to 8%; baking powder 0.05 to 2.0%; salt 0 to 1.5%; flavors 0-3%; and inclusions 0-15% by weight. All % by weight based on the total weight.

Acceptable ingredient substitutes can be considered for the batter. For example, with respect to flour, examples of such flours include, but are not limited to all-purpose flour, hard wheat flour, bleached wheat powder, soft wheat flour, whole wheat flour, corn flour, oat flour, rice flour, soy flour, barley flour, and mixtures thereof. With respect to shortening, examples include, but are not limited to, liquid shortening, solid shortening, vegetable oil, tallow, tropical oils and mixtures thereof. With respect to eggs, fresh, liquid, examples include, but are not limited to, liquid and dry whole eggs, and liquid and dry egg whites, soy egg substitutes and mixtures thereof. With respect to whey powder, sweet, examples include, but are not limited to, nonfat dry milk, whole milk solids, casein, hydrolyzed milk protein, milk protein isolate, whole milk, partially defatted milk, skim milk, whey, and mixtures thereof. With respect to sugar, granulated, examples include, but are not limited to, sucrose, dextrose, fructose, lactose, malt syrup, malt syrup solids, rice syrup solids, rice syrup, invert sugar, refiners syrup, corn syrup, corn syrup solids, maltose, high fructose corn syrup, honey, molasses, and mixtures thereof. With respect to baking powder, any suitable blend of a gassing agent, i.e. sodium bicarbonate, and an activating acid(s), i.e. monocalcium phospate can be made to work. Examples include, but are not limited to, ammonium bicarbonate, potassium bicarbonate, and sodium bicarbonate, sodium aluminum phosphate, fumaric acid, adipic acid, acetic acid, tartaric acid, monocalcium phosphate monohydrate, anhydrous monocalcium phosphate, anhydrous dicalcium phosphate, dicalcium phosphate dihydrate, sodium acid pyrophosphate, monoaluminum phosphate, dialuminum phosphate, monoammonium phosphate, diammonium phosphate, and mixtures thereof. Yeast leavened batters have also been used particularly on European Waffle products.

With respect to salt, examples include, but are not limited to, potassium chloride, calcium chloride and mixtures thereof. With respect to optional ingredients many can be included as described below. Fruit from a variety of sources can be incorporated into the batter. Fruit can be added as an inclusion by blending in Individually Quick Frozen fruit or dried fruit, e.g. freeze dried, sugar infused, dried, etc. Fruit can also be solubilized into a batter by adding it as a fruit powder, fruit puree or concentrate. Fiber can be added to the batter in many forms, both soluble and insoluble fiber. Kellogg's® All Bran is an excellent source of an insoluble fiber that works particularly well in batter products due to it's superior flavor properties. Obviously, many forms of insoluble fiber are available. Soluble fiber sources such as Oat Bran. A protein source 0 to 10% in addition to the protein inherent in other batter ingredients can be included in the batter. Examples of protein include, but are not limited to, egg albumen, whey, whey protein concentrates or isolates, soy flour, soy protein concentrate or isolates, vital wheat gluten, peanut protein, pea protein, and mixtures thereof. Emulsifier 0 to 2% can be added; examples include, but are not limited to, mono- and di-glycerides, propylene glycol monoester and diester, sodium steroyl lactylate, lecithin, polysorbate, sorbitan monostearate, glyceryl lacto ester, and mixtures thereof. With respect to calcium carbonate, examples include, but are not limited to, calcium citrate, calcium gluconate, calcium lactate, calcium caseinate, calcium chloride, calcium citrate malate, calcium glycerophosphate, calcium hydroxide, calcium malate, calcium stearate, calcium sulfate, and mixtures thereof. Gum 0 to 1% can be added; examples include, but are not limited to, xanthan gum, guar gum, carboxymethylcellulose gum, hydroxypropylmethocellulose gum, alginates, pectins, gelatin to name a few and mixtures thereof. Starch 0 to 3% can be added; examples include, but are not limited to, corn starch, wheat starch, potato starch, tapioca starch, and mixtures thereof. Starches can be modified as know in the art and can be pregelatinized. Flavoring agents (natural and artificial) 0 to 2% can be added. Antimycotic preservatives 0.05 to 1% can be added; examples include, but are not limited to, sodium benzoate, potassium sorbate, and mixtures thereof. Fortificants and colors can be added; examples include, but are not limited to, ascorbic acid, beta carotene, biotin, calcium pantothenate, choline, folic acid, niacin, Vitamin A, Vitamin B₁, Vitamin B₂, Vitamin B₆, Vitamin B₁₂, Vitamin D₂, Vitamin D₃, niacinamide, Vitamin E, Vitamin K, boron, calcium, Chromium, copper, iodine, iron, magnesium, molybdenum, nickel, potassium, selenium, vanadium, zinc, natural color, artificial color, and mixtures thereof. Inclusions can be added; examples include but are not limited to, nuts, dried or fresh fruits, candy pieces, colored sugar, restructured fruit pieces, chocolate drops, confectionery drops, spices, herbs, cereal pieces, cereal grains, seeds, restructured or dried meats and meat substitutes, frozen or dried vegetables, dehydrated or fresh cheese and cheese analogs, dried or fresh coconut and mixtures thereof.

In a most preferred embodiment of the invention, the first batter can be 41% water, 41% wheat flour, 8% shortening, 6% liquid eggs, 2% granulated sugar, 0.6% salt, 0.5% baking powder, and 0.1% Carmel Color.

The process continues from step 12 to step 24 wherein the batter forming the decorative food product 14 is partially cooked for a first period of time while the cavity 20 is substantially empty, the baking surface 8 substantially exposed. During the cooking process, a skin 26 forms along an outer surface of the decorative food product 14 adjacent to the portion 22 of the mold half 18. The decorative food product 14 is only partially cooked during step 24 such that a portion 28 remains uncooked. A moist, tacky surface 30 of the decorative food product 14 faces upwardly toward the cavity 20 after the partial cooking step.

A heater 32 heats the mold 16 to cook the food product 14. The heater 32 can communicate heat to the first mold half 18 and also communicates heat to a second mold half 34 of the mold 16. The heater 32 heats the mold 16 by any means known in the art, such as electrical resistive heat, combustion, or heat transfer by circulating fluid.

After the decorative food product 14 is partially cooked in step 24, the process continues to step 36 wherein a base food product 38 is placed in the cavity 20 in contact with the tacky surface 30 of the decorative food product 14 and with the baking surface 8. A surface 40 of the base food product 38 engages the tacky surface 30. The base food product 38 can be any pre-prepared, or partially prepared food product. In other words, the base food product 38 can be relatively rigid. By example and not limitation, the base food product 38 can be bread, a sandwich, a toaster pastry, a pancake, a waffle, a biscuit, a roll, a snack bar, a baked snack treat, or a partially-baked snack treat. The base food product 38 can be formed as uncooked dough, partially cooked dough, or can be a substantially pre-prepared food product.

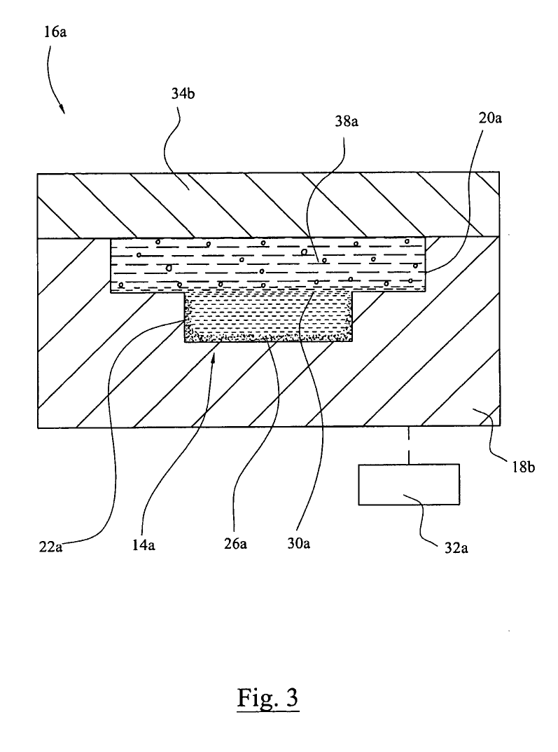

Alternatively, as shown in FIG. 3, the base food product 38a can be an uncooked batter. The batter 38a can be dispensed into a cavity 20a after the decorative food product 14a has been partially or fully cooked in a recessed portion 22a defined by a first mold half 18b of a mold 16a, to form a skin 26a and a moist, tacky surface 30a or a fully cooked decorative food component 14a. The extent of cooking for the decorative food product 14a can be selected in response to the base food product 38a. For example, if the base food product 38a is a form of batter, the decorative food product 14a can be relatively more cooked since the batter of the base food product 38a will promote adhesion between the base food product 38a and the decorative food product 14a. On the other hand, if the base food product 38a is a form of a partially prepared food product like bread or a pastry, the decorative food product 14a can be relatively less cooked to enhance the likelihood that the decorative food product 14a defines a tacky surface to promote adhesion between the base food product 38a and the decorative food product 14a. A heater 32a heats the mold 16a to cook the food product 14a. The batter used for forming the base food product 38a, can be any type of batter used for forming edible food products.

The batter for forming the base food product 38a can be the same as the batter for forming the decorative food product 14a. Alternatively, the batter for forming the base food product 38a can be different than the batter for forming the decorative food product 14a. It can be desirable to form the composite food product with two different types of batter, wherein the cooked decorative food product 14a and the cooked base food product 38a define different textures, colors, flavors, and/or aromas.

The batter for forming the decorative food product 14 can be leavened less than the batter for forming the base food product 38. Experiments on this invention with Kellogg's® Eggo Waffles clearly showed that the decorative food image appearance was clearly enhanced by reducing the leavening from a typical 2% Baking Powder used in many waffle batters. By reducing the leavening of the batter forming the decorative food product 14, the finished decorative food product 14 can have a smoother skin than the relatively greater leavened base food product 38. Furthermore, the batter for forming the decorative product 14 can be a yeast leavened product and the batter for forming the base food product 38 can be chemically leavened, or vice-versa.

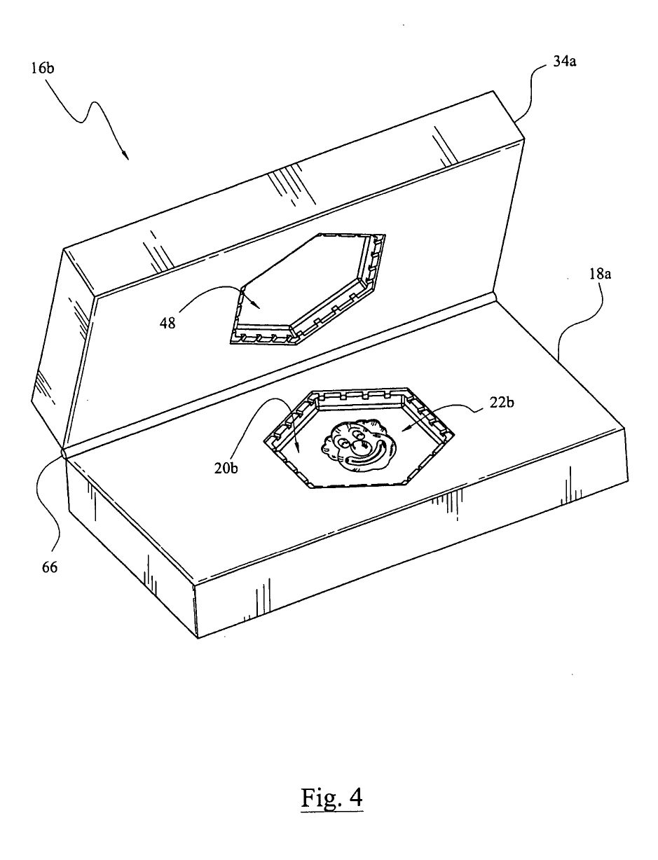

Referring again to FIGS. 1 and 2, after the base food product 38 is placed in the cavity 20, the process continues to step 42 wherein the cavity 20 is closed with the second mold half 34. The mold 16 can include releasable locking means 62 and 64 to prevent the mold halves 18, 34 from moving relative to one another, especially during cooking of the decorative food product 14 and the base food product 38 together, described in greater detail below. Locking means 62, 64 can be over-center clamps, pins, bolts, or any attaching means. Alternatively, as shown in FIG. 4, the mold halves 18a, 34a of the mold 16b can be rotatably associated with respect to one another along a hinge 66. Alternatively, as shown in FIG. 3, the mold halves 18b, 34b can float with respect to one another to allow expansion of the batter of the decorative food product 14a and the base food product 38a during cooking.

Referring now to FIG. 4, a mold 16b according to one embodiment of the invention includes the first mold half 18a and the second mold half 34a. The first mold half 18a defines a first cavity 20b and a recessed portion 22b. Building on the central invention, it is possible to have recesses within the recess which would enable highly detailed decorative patterns consisting of 2 or more colors or flavors or textures. One can manufacture a waffle with a pink clown face, red nose and blue eyes. Further, the recess are can be partitioned into areas for multi-batter deposits. For example, one can manufacture a pancake with a 3-D Maple Tree image where the top half of the tree is green and the bottom half is brown. The portion 22b can be formed to correspond to a graphical image or three dimensional textual indicia. The second mold half 34a defines a second cavity 48. The second cavity 48 can be formed in the mold half 34a to enhance the cooking of the base food product 38 and the decorative food product 14 together or to enhance the removal of the decorative food product 14 and the base food product 38 from the mold 16b.

Referring again to FIGS. 1 and 2, the process continues to step 44 after the cavity 20 is closed and the decorative food product 14 and the base food product 38 are cooked together for a second period of time. The second cooking step 44 can enhance engagement between the food products 14, 38. The tacky surface 30 and the surface 40 can bond together during the cooking step 44. After the decorative food product 14 and the base food product 38 have been cooked together, the process ends at step 46.

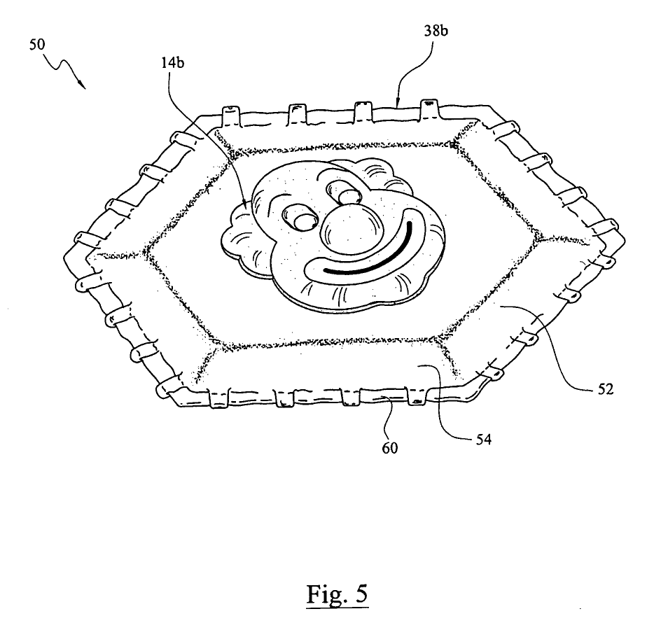

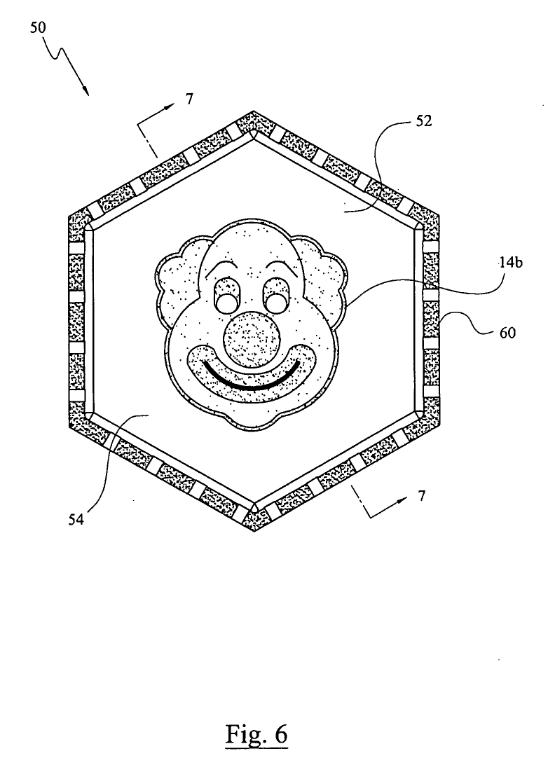

An embodiment of the invention is shown in FIGS. 5-7. The method of the present invention can produce a composite food product 50 including a decorative food product 14b adhered to a base food product 38b. The decorative food product 14b can extend from an outer surface 52 of the base food product 38b. The decorative food product 14b can be formed as a graphical image, such as a clown. The base food product 38b can be a sandwich prepared by another process. For example, the base food product 38b can be a grilled cheese sandwich including a first slice of bread 54 and a second slice of bread 56. A filling 58, such as cheese, can be disposed between the slices 54, 56. The slices 54, 56 can be joined at a crimped edge 60 extending the length of the periphery of each of the slices 54, 56. A method and apparatus for forming the crimped edge 60 is shown in U.S. Pat. No. 6,004,596, which is hereby incorporated by reference into the present application.

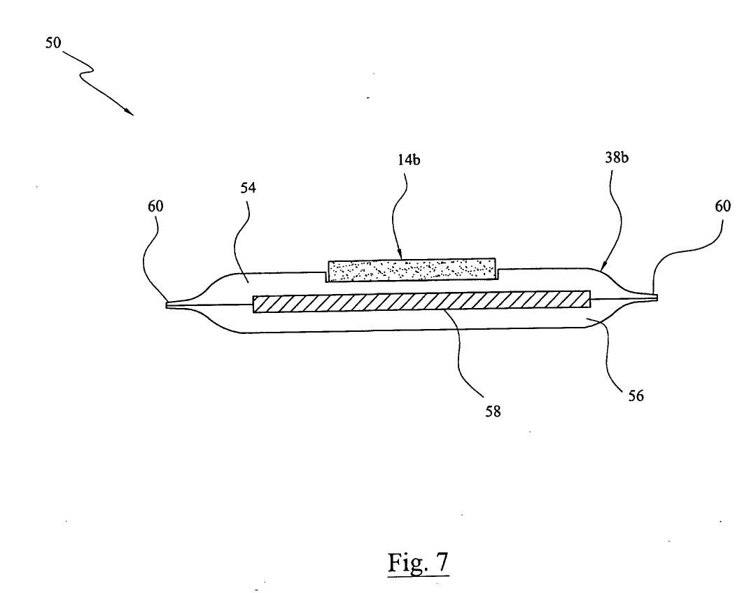

The composite food product 50 is shown in alternative embodiments in FIGS. 5 and 7, respectively. In FIG. 5, the composite food product 50 defines a complex geometric surface wherein the nose of the clown extends out from the base food product 38b greater than the cheeks of the clown. Similarly, the cheeks and forehead of the clown extend out from the base food product 38b greater than the hair of the clown. FIG. 7 shows an alternative wherein the entire clown face is flat.

In preparation of the cooking steps 24 and 44, the cavities 20, 20a, 20b, the portions 22, 22a, 22b and the cavity 48, can be coated with butter, margarine or any release agent to enhance removal of the cooked food products 14, 14a, 14b, 38, 38a, and 38b from the molds 16, 16a, 16b, respectively. Alternatively, the food products 38 and 38b can be coated with butter, margarine or a release agent. However, it is recommended that the surface area of the food products 38, 38b, that contact the decorative food product 14, 14a, 14b are lightly or not coated with a release agent.

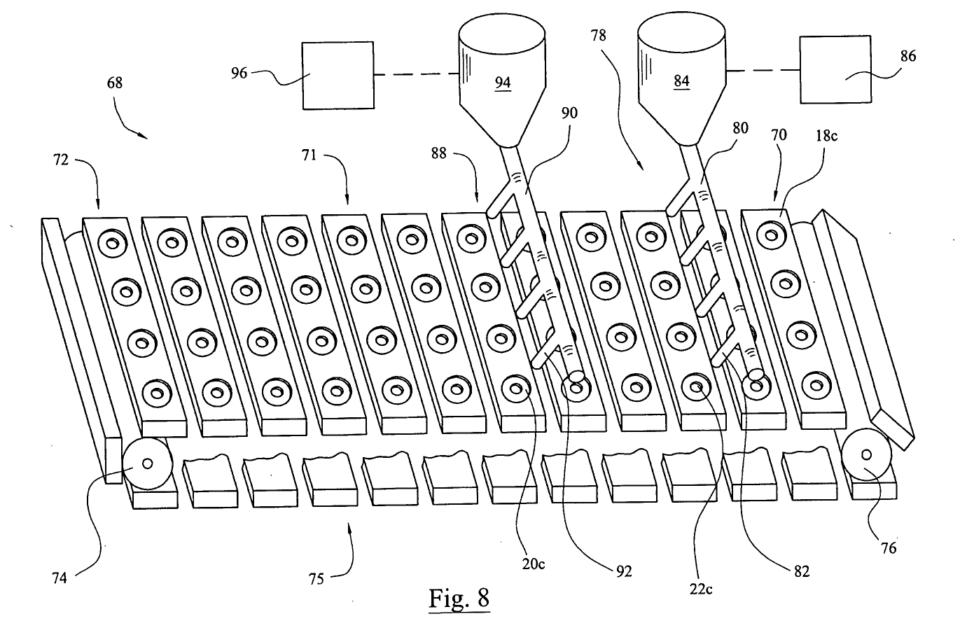

Referring now to FIG. 8, an assembly line for preparing a Decorative Toaster Muffin food product according to one embodiment of the invention includes an endless conveyor 68. A plurality of mold halves 18c can be rotatably connected with respect to one another and connected to a conveyor chain (not shown) for movement along the endless conveyor 68. Each mold half 18c moves from a beginning 70 of a production portion 71 of the endless conveyor 68, to an end 72 of the production portion 71. Each mold half 18c can travel around an axle 74, along a return portion 75 of the endless conveyor 68, and around a second axle 76 to the beginning 70 of the production portion 71.

The mold half 18c travels along the production portion 71 to a first work station 78. The work station 78 includes a dispensing means 84 and a dispensing manifold 80, including a plurality of dispensing tips 82. Each dispensing tip 82 is aligned with one of a plurality of recessed portions 22c of the mold half 18c. The dispensing manifold 80 receives a stream of a first batter for a decorative food product 14 from dispensing means 84 and dispenses the first batter into a plurality of portions 22c through the tips 82. Dispensing means 84 can include a piston pump or a volume control pump such a screw pump powered by a servo motor. Dispensing means 84 can be in fluid communication with a holding container 86 of the first batter.

After the first batter is dispensed in the plurality of portions 22c, the mold half 18c moves along the endless conveyor 68 to a second work station 88. During movement of the mold half 18c between the first work station 78 and the second work station 88, the mold half 18c is heated to partially cook the batter contained in the portions 22c. The first and second work stations 78, 88 are spaced apart relative to one another to ensure adequate time for the desired partial cooking of the first batter. The exact time required is very dependant upon the baking surface temperature, batter/dough formulation and the base product. In general, most applications work in a 2 to 20 second time window though testing with relatively cool cake pans has exceeded 5 minutes. In addition, the temperature to which the mold half 18c is heated can be varied in response to the distance between the first and second work stations 78, 88 to ensure desired partial cooking of the first batter. The second work station 88 includes a second dispensing manifold 90 for dispensing batter or dough of a base food product 38 into a plurality of cavities 20c formed in the second mold half 18c through tips 92. The manifold 90 is in communication with a second batter/dough dispensing means 94. The dispensing means 94 can include a piston-type pump or a controlled positive displacement or volume pump, such as a screw pump in combination with a servo motor or any other depositor as known by those practiced in the art. The dispensing means 94 can be in fluid communication with a holding container 96 of the second batter/dough.

The mold half 18c moves from the second work station 88 to the end 72 of the production portion 71 of the endless conveyor 68. During movement to the end 72, the decorative food product 14 and the base food product 38 are cooked so they bond together. The length of the conveyor 68 between the second work station 88 and the end 72 can be varied in response to the time required for cooking the decorative food product 14 and the base food product 38. The composite food product 50 is released from the mold 18c by gravity when the mold 18c is rotated around the axle 74. If necessary the food product 50 can be released onto a second conveyor for cooking of the side not having the decorative food product 14.

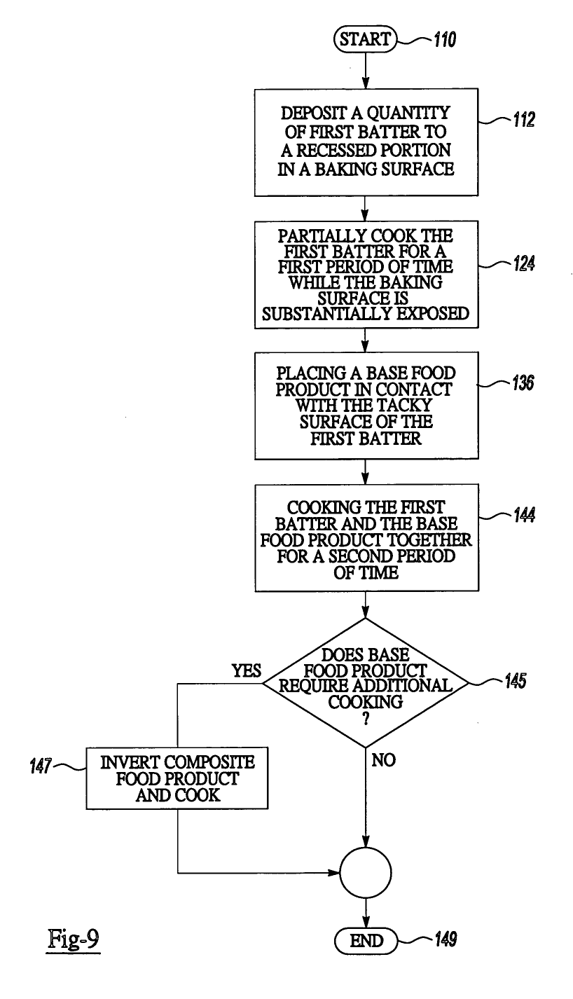

Another embodiment of the method disclosed by the present invention is shown in the simplified flow diagram of FIG. 9, wherein a baking surface is defined by a griddle and includes a recessed portion. The process starts at step 110. The process continues to step 112 wherein a first batter for forming a decorative food product is deposited on a recessed portion of a baking surface. The recessed portion can be shaped to correspond to a graphical image, such as the shape of an animal, an object, a symbol, or a logo. In addition or alternatively, the recessed portion can be shaped to correspond to textual, three-dimensional indicia, such as a word, a phrase, a number, or a letter.

The process continues from step 112 to step 124 wherein the batter forming the decorative food product is partially cooked for a first period of time while the baking surface is substantially exposed. During the cooking process, a skin forms along an outer surface of the decorative food product adjacent to the recessed portion. The decorative food product is only partially cooked during step 124 such that a portion remains uncooked. A moist, tacky surface of the decorative food product faces upwardly adjacent to the baking surface.

After the decorative food product is partially cooked in step 124, the process continues to step 136 wherein a base food product is placed over the recessed portion in contact with the tacky surface of the decorative food product. A surface of the base food product engages the tacky surface. The base food product can be any pre-prepared, or partially prepared food product. In other words, the base food product can be relatively rigid. By example and not limitation, the base food product can be bread, a sandwich, a toaster pastry, a pancake, a waffle, a biscuit, a roll, a snack bar, a baked snack treat, or a partially-baked snack treat. The base food product can be formed as uncooked dough, partially cooked dough, or can be a substantially pre-prepared food product.

The process continues to step 144 and the decorative food product and the base food product are cooked together for a second period of time. The second cooking step can enhance engagement between the food products. The tacky surface and the surface can bond together during the cooking step 144.

After the decorative food product and the base food product have been cooked together at step 144, the process continues to step 145 to determine whether the base food product requires a cooking on a side opposite the decorative food product. For example, if the base food product is pancake batter or biscuit dough, additional cooking can be required to complete the composite food product. If the additional cooking is required, the process continues to step 147 and the combined base food product and decorative food product is inverted, or flipped, to cook the base food product for a third predetermined period of time. Automated systems for griddle-prepared food products can be acquired from TSA Griddle Systems in Kelowna, British Columbia, Canada. The process ends at step 149.

The base food product can take many forms and for the sake of explaination in this application, the two basic forms are those requiring cooking and those that could be eaten prior to applying the decorative edible image. In the case of a pancake with a decorative edible 3-D image, the base product would typically be pancake batter. In the case of a Hot Dog bun with a decorative edible 3-D image, the base product would be a ready to eat Hot Dog bun. In the case of French Toast with a decorative edible 3-D image, the base product would typically be the slice of bread freshly soaked in a raw milk/egg solution that would require cooking.

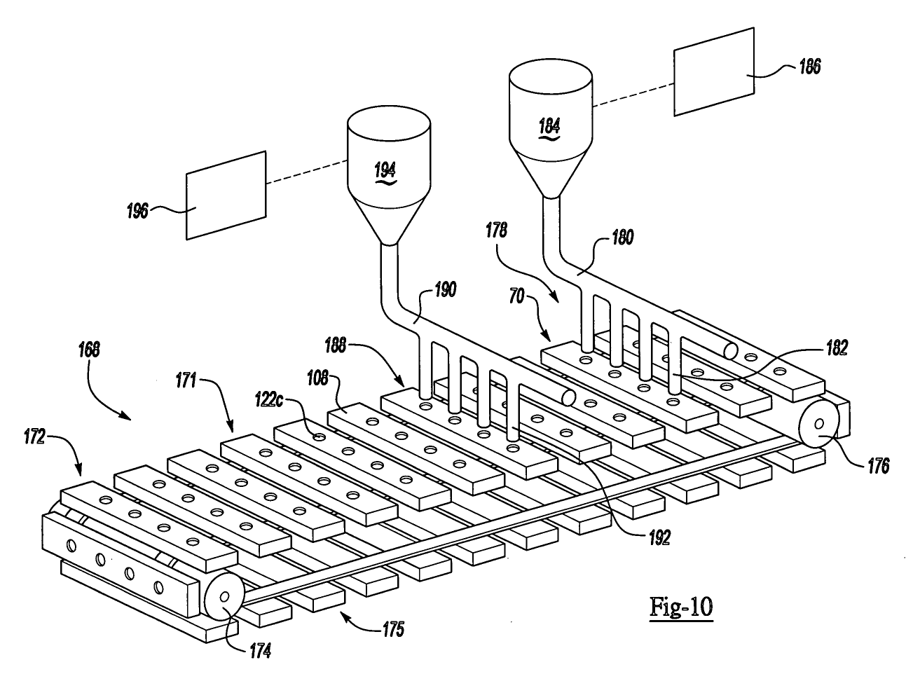

Referring now to FIG. 10, an assembly line for preparing a food product according to the second embodiment of the invention includes an endless conveyor 168. A plurality of baking surfaces 108 can be rotatably connected with respect to one another and connected to a conveyor chain (not shown) for movement along the endless conveyor 168. Each baking surface 108 moves from a beginning 170 of a production portion 171 of the endless conveyor 168, to an end 172 of the production portion 171. Each baking surfaces 108 can travel around an axle 174, along a return portion 175 of the endless conveyor 168, and around a second axle 176 to the beginning 170 of the production portion 171.

The baking surface 108 travels along the production portion 171 to a first work station 178. The work station 178 includes a dispensing means 184 and a dispensing manifold 180, including a plurality of dispensing tips 182. Each dispensing tip 182 is aligned with one of a plurality of recessed portions 122c of the baking surface 108. The dispensing manifold 180 receives a stream of a first batter for a decorative food product from dispensing means 184 and dispenses the first batter into a plurality of portions 122c through the tips 182. Dispensing means 184 can include a piston pump or a volume control pump such a screw pump powered by a servo motor. Dispensing means 184 can be in fluid communication with a holding container 186 of the first batter.

After the first batter is dispensed in the plurality of portions 122c, the baking surface 108 moves along the endless conveyor 168 to a second work station 188. During movement of the baking surface 108 between the first work station 178 and the second work station 188, the baking surface 108 is heated to partially cook the batter contained in the portions 122c. The first and second work stations 178, 188 are spaced apart relative to one another to ensure desired partial cooking of the first batter. In addition, the temperature to which the baking surface 108 is heated can be varied in response to the distance between the first and second work stations 178, 188 to ensure desired partial cooking of the first batter. The second work station 188 includes a second dispensing manifold 190 for dispensing batter or dough of a base food product on baking surface 108 through tips 192. The manifold 190 is in communication with a second batter/dough dispensing means 194. The dispensing means 194 can include a piston-type pump or a controlled volume pump, such as a screw pump in combination with a servo motor. The dispensing means 194 can be in fluid communication with a holding container 196 of the second batter/dough.

Snack cakes or full sized cakes with decorative edible 3-D patterns can be made in a similar manner. A recess area in the baking pan would define the shape of the decorative pattern. After depositing the first batter, the bottom of the cake pan would subjected to sufficient, localized heat to partially cook and form a skin. The base product, cake batter, would then be deposited as normal and the filled baking pan would be conveyed into a standard commercial oven. Baking, cooling, depanning, post processing and packaging would proceed as normal for the product.

The baking surface 108 moves from the second work station 188 to the end 172 of the production portion 171 of the endless conveyor 168. During movement to the end 172, the decorative food product and the base food product are cooked so they bond together. The length of the conveyor 168 between the second work station 188 and the end 172 can be varied in response to the time required for cooking the decorative food product and the base food product. The composite food product is released from the baking surface 108 by gravity when the baking surface 108 is rotated around the axle 174. In alternative embodiments of the invention, the composite food product can be flipped at the end 172 of the conveyor 168 to cook a surface of the base food product that is opposite of the decorative food product.

In the embodiments set forth above, the baking surface defines a recessed portion for received the quantity of first batter. In at least one of the embodiments, the baking surface is defined in a cavity of a mold and, in another embodiment, the baking surface is defined on an open griddle. In alternative embodiments of the invention, the quantity of first batter can be deposited on a substantially flat baking surface. In other words, the baking surface can be without a recessed portion. The baking surface without recessed portion can be defined by a waffle iron, a griddle, a mold, a baking pan or any other cooking surface in the art. For example, a quantity of first batter can be deposited on a the baking surface, cooked for the first predetermined period of time, and then covered by the base food product.

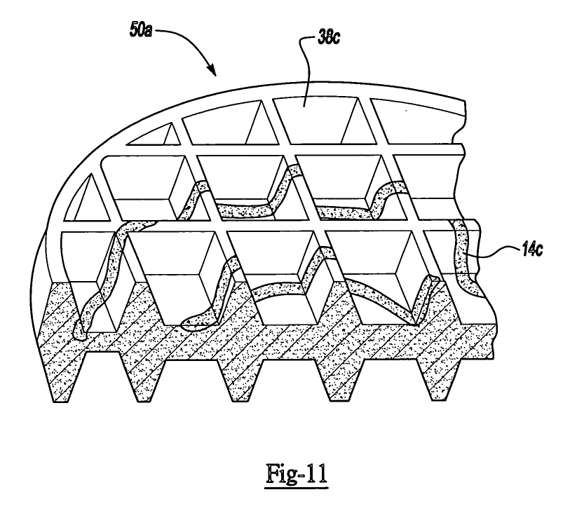

In one example, shown in FIG. 11, the quantity of first batter 14c is colored dark brown and cinnamon flavored. The quantity of first batter 14c is deposited in a swirl pattern on a conventional waffle iron. In another alternative embodiment, the first batter 14c could be deposited in a swirl pattern on a conventional griddle. After the quantity of first batter 14c is cooked for the first predetermined period of time, a base food product 38c of conventional waffle batter is placed or deposited over the at least partially cooked quantity of first batter 14c. The base food product 38c and first batter 14c are cooked together for the second predetermined period of time. If the base food product 38c were pancake batter and the baking surface was defined by a conventional griddle, the composite food product 50a would, if necessary, be flipped and cooked for the third predetermined period of time. The resulting composite food product 50a includes a portion that is both decorative through color differentiation and aesthetic through taste differentiation. The resulting composite food product 50a is a waffle or pancake resembling a cinnamon roll.

In another example, the quantity of first batter is a first color and is deposited in a tic-tac-toe or lattice pattern on a conventional waffle iron or griddle. After the quantity of first batter is cooked for the first predetermined period of time, a base food product of conventional pancake batter is placed or deposited over the at least partially cooked quantity of first batter. The base food product and first batter are cooked together for the second predetermined period of time, and, if necessary, flipped and cooked for the third predetermined period of time. The resulting composite food product includes a portion that is both decorative through color differentiation and aesthetic by defining a game surface. For waffle, after the quantity of first batter is cooked for the first predetermined period of time, a base food product of conventional waffle batter is placed or deposited over the at least partially cooked quantity of first batter. The top mold is placed on the bottom mold holding the batter deposites and base food product and first batter are cooked together for the second predetermined period of time. The resulting composite food product is a waffle or pancake which can be used to play tic-tac-toe.

### EXAMPLE 1

In a first example for applying a three-dimensional shape to a hamburger bun, the batter can be formed, in terms of Baker's percentage, with 100% wheat flour, 75% water, 1% yeast, 2.5% salt, 0.05% yellow coloring #5 and #6 blend, 3% sweetener, and 12% melted shortening. The ingredients are added together in a liquifier and mixed to a homogenous, pumpable batter. Preferably, the ingredients are mixed for approximately 60 seconds. Approximately 7 grams, or 1/4of an ounce, of the batter is placed in the recessed portion of the mold for approximately 5 to 15 seconds at a temperature of 325° F. After the batter in the recessed portion is partially cooked, a hamburger bun can be added to the cavity adjacent to the partially cooked batter. The combined food product can be cooked for 30-45 seconds.

### EXAMPLE 2

In a second example of the invention, for applying a three-dimensional shape to a hotdog bun, a batter can be formed, in terms of baker's weight, with 100% wheat flour, 82% water, 8% oil, 2.25% salt, 1% flavor seasoning blend, 7% sweetener in the form of corn syrup, and 0.5% baking powder. The batter can be mixed together in a liquifier and formed into a homogenous, pumpable batter. Preferably, the ingredients are mixed for approximately 60 seconds. Four grams or 1/7 of an ounce of batter can be dispensed into the recessed portion of the mold and cooked for 3 to 15 seconds at a temperature of 350° F. A hotdog bun can be added to the cavity of the mold and the combined food product can be cooked together for 20 to 40 seconds.

### EXAMPLE 3

In a third example of the invention, for applying a three-dimensional shape to a pancake, a batter can be formed in terms of standard percentages, with 35% flour, 35% water, 2% salt, 0.15% caramel food coloring, 0.3% maple flavor, 8% sweetener, 0.5% baking powder, 10% fat in the form of shortening or oil, 5% eggs, and 1% whey. The ingredients can be mixed together in a liquifier and formed into a homogenous pumpable batter. Preferably, the ingredients are mixed for approximately 60 seconds. Twelve grams of the batter can be dispensed into a recessed portion of the mold defining the shape of a maple tree. The batter can be cooked for 15 seconds at 325° F. After the batter has been partially cooked, an additional 35 grams of the batter are added to the cavity of the mold and the combined food product is cooked for approximately 75 seconds.

While the invention has been described in connection with several embodiments, it is to be understood that the invention is not to be limited to the disclosed embodiment, but, on the contrary, is intended to cover modifications and equivalent arrangements that are within the spirit and scope of the claims. The claims are to be accorded the broadest interpretation to encompass all such modifications and equivalent structures as permitted under the law. It is also to be understood that any feature of the invention shown in one embodiment can be used in combination with any of the other embodiments or features shown in other embodiments.

1. A method comprising the steps of:
depositing a quantity of a first batter on a baking surface;
first cooking the first batter on the baking surface for a first period of time;
placing a base food product over the first batter on the baking surface; and
second cooking both the base food product and the first quantity of batter for a second period of time to bond the first batter to the base food product.

2. The method of claim 1 wherein the depositing step is further defined as:
depositing a quantity of a first batter on a baking surface in a predetermined pattern.

3. The method of claim 1 including the step of:
selecting one of a second batter, dough and an at least partially prepared food product for the base food product.

4. The method of claim 1 including the steps of:
selecting the first batter and the base food product to be different from one another with respect to at least one of color, taste and texture.

5. The method of claim 1 including the steps of:
defining a recessed portion in the baking surface;
positioning at least one of the first batter and the base food product in the recessed portion.

6. The method of claim 1 wherein the first cooking step includes the step of:
forming a skin only along an outer surface of the first batter adjacent to the baking surface; and
maintaining a tacky outer surface of the first batter substantially opposite the skin.

7. The method of claim 6 wherein the placing step is further defined as:
placing the base food product over the first batter on the baking surface in contact with the tacky outer surface.

8. The method of claim 1 including the step of:
selecting two or more different materials for at least one of the first batter and the base food product.

9. A method comprising the steps of:
defining a recessed portion in a baking surface;
depositing a quantity of a first batter on the recessed portion of the baking surface;
first cooking the first batter in the recessed portion of the baking surface for a first period of time while the baking surface is substantially exposed;
placing a base food product over the first batter in the recessed portion of the baking surface and in contact with the first batter; and
second cooking both the base food product and the first quantity of batter for a second period of time to bond the first batter to the base food product.

10. The method of claim 9 wherein the defining step is further defined as:
defining the recessed portion in the baking surface of a griddle.

11. The method of claim 9 wherein the defining step is further defined as:
defining a recessed portion in a baking surface of a waffle iron.

12. The method of claim 9 wherein the defining step is further defined as:
defining a recessed portion in a baking surface of a mold.

13. The method of claim 9 wherein the defining step is further defined as:
defining a recessed portion in a baking surface of a baking pan.

14. The method of claim 9 wherein the depositing step is further defined as:
depositing a quantity of a first aerated batter on the recessed portion of the baking surface.

15. The method of claim 9 wherein the first cooking step is further comprises the steps of:
forming a skin only along an outer surface of the first batter adjacent to the recessed portion; and
maintaining a tacky outer surface adjacent to the baking surface.

16. The method of claim 9 including the step of:
defining the baking surface in a cavity of a mold.

17. The method of claim 9 wherein the placing step is further defined as:
placing a base food product in the form of a slice of french toast over the recessed portion in contact with the first batter.

18. The method of claim 9 wherein the placing step is further defined as:
placing a base food product in the form of a sandwich over the recessed portion in contact with the first batter.

19. The method of claim 9 wherein the placing step is further defined as:
placing a base food product in the form of a cookie over the recessed portion in contact with the first batter.

20. The method of claim 9 wherein the placing step is further defined as:
placing a base food product in the form of a pastry over the recessed portion in contact with the first batter.

21. The method of claim 9 wherein the placing step is further defined as:
placing a base food product in the form of a chemically-leavened biscuit over the recessed portion in contact with the first batter.

22. The method of claim 9 wherein the placing step is further defined as:
placing a base food product in the form of a yeast-raised roll over the recessed portion in contact with the first batter.

23. The method of claim 9 wherein the placing step is further defined as:
placing a base food product in the form of a baked snack bar over the recessed portion in contact with the first batter.

24. The method of claim 9 including the step of:
covering at least a portion of the baking surface with a release agent before the depositing step.

25. The method of claim 9 including the step of:
selecting two or more different materials for at least one of the first batter and the base food product.

26. A method comprising the steps of:
defining a recessed portion in a baking surface in a cavity of a first mold half;
depositing a quantity of a first batter on the recessed portion of the baking surface by substantially filling only the recessed portion of the first mold half;
first cooking the first batter in the recessed portion of the baking surface for a first period of time while the baking surface is substantially exposed and while the cavity is substantially empty;
placing a base food product in the cavity over the first batter in the recessed portion of the baking surface and in contact with the first batter; and
second cooking both the base food product and the first quantity of batter for a second period of time to bond the first batter to the base food product.

27. The method of claim 26 wherein the first cooking step includes the steps of:
forming a skin only along an outer surface of the first batter adjacent to the recessed portion from the cavity; and
maintaining a tacky outer surface adjacent to the cavity.

28. The method of claim 26 including the step of:
substantially enclosing the cavity and the recessed portion with a second mold half after the placing step.

29. The method of claim 28 wherein the enclosing step is further defined as:
substantially preventing expansion of the base food product out of the cavity.

30. The method of claim of 26 wherein the placing step is further defined as:
dispensing at least one of a second batter and a dough in the cavity over the first batter.

31. The method of claim of 26 wherein the placing step is further defined as:
inserting a prepared food item in the cavity.

32. The method of claim 31 including the step of:
selecting the prepared food item from the group consisting of sandwich, toaster muffin, and English muffin.

33. The method of claim 26 including the step of:
selecting two or more different materials for at least one of the first batter and the base food product.

34. The method of claim 26 including the step of:
forming the recessed portion to correspond to textual indicia.

35. The method of claim 26 including the step of:
forming the recessed portion to correspond to graphical indicia.

36. A method comprising the steps of:
defining a recessed portion in a baking surface in a cavity of a first mold half;
first heating the first mold half to a cooking temperature;
depositing a quantity of a first batter on the recessed portion of the baking surface by substantially filling only the recessed portion of the first mold half;
first cooking the first batter in the recessed portion of the baking surface for a first period of time while the baking surface is substantially exposed and while the cavity is substantially empty;
placing a base food product in the cavity over the first batter in the recessed portion of the baking surface and in contact with the first batter;
substantially enclosing the cavity with a second mold half after the placing step;
second heating the second mold half to the cooking temperature; and
second cooking both the base food product and the first quantity of batter for a second period of time to bond the first batter to the base food product.
